(19) United States
(12) Patent Application Publication
(10) Pub. No.: US 2017/0317861 A1
(43) Pub. Date: Nov. 2, 2017

(54) RADIO DEVICE AND COEFFICIENT UPDATE METHOD

(71) Applicant: FUJITSU LIMITED, Kawasaki-shi (JP)

(72) Inventors: Satoshi Matsubara, Kawasaki (JP); Akihiko Komatsuzaki, Kawasaki (JP)

(73) Assignee: FUJITSU LIMITED, Kawasaki-shi (JP)

(21) Appl. No.: 15/469,875

(22) Filed: Mar. 27, 2017

(30) Foreign Application Priority Data
Apr. 28, 2016 (JP) 2016-091777

(51) Int. Cl. H04L 25/08; H04W 52/52

(52) U.S. Cl. CPC H04L 25/085; H04W 52/52

(57) ABSTRACT

A radio device includes an amplifier; a storage that stores therein distortion compensation coefficients each of which compensates distortion that is generated in the amplifier; an updater that reads, from the storage in a first time section, the distortion compensation coefficients associated with a portion of an input signal input during the first time section and stores the read distortion compensation coefficients in a memory, and that updates, in a second time section, the distortion compensation coefficients stored in the memory and writes the updated distortion compensation coefficients in the storage; and a controller that controls the updater such that, when the same input signal is repeatedly input, the distortion compensation coefficients associated with a portion that is different from the portion of the input signal input the last time are stored in the memory in the first time section.

### CROSS-REFERENCE TO RELATED APPLICATION

This application is based upon and claims the benefit of priority of the prior Japanese Patent Application No. 2016-091777, filed on Apr. 28, 2016, the entire contents of which are incorporated herein by reference.

### FIELD

The embodiments discussed herein are directed to a radio device and a coefficient update method.

### BACKGROUND

In recent years, for example, in a radio communication system, such as a mobile unit communication system, or the like, data is transmitted with high efficiency due to digitization. Specifically, for example, a multilevel phase modulation scheme is sometimes used in order to transmit multiple-bit data by a single symbol. If the multilevel phase modulation scheme is used in the radio communication system, at the transmission side, it is desirable to control nonlinear distortion by linearizing the characteristic of amplification of an electrical power amplifier that amplifies a transmission signal. However, in order to enhance the linearity of the electrical power amplifier, there is a need to use an expensive device or to increase the voltage applied to the electrical power amplifier, resulting in an increase in cost or electrical power consumption.

Thus, as a technology of distortion compensation that compensates nonlinear distortion generated in the electrical power amplifier, for example, a digital nonlinear distortion compensation (digital predistortion: DPD) scheme is sometimes used. The DPD compensates nonlinear distortion by multiplying a transmission signal by a distortion compensation coefficient that has the inverse characteristic of the nonlinear distortion generated in the electrical power amplifier. The amplitude of the transmission signal and the amplitude of a feedback signal that is fed back after amplification are subjected to digital transformation and compared and then the distortion compensation coefficient is updated in real time on the basis of the comparison result.

Various methods are used to implement the DPD and, in general, a lookup table (LUT) method is known. The LUT method is a method that determines the address on the basis of electrical power of an input signal and that refers to and updates the distortion compensation coefficients stored in the LUT. In this way, because a plurality of accesses, such as reference and an update, are performed on the LUT, a dual port random access memory (dual ported RAM) is often used as an LUT.

There are two types of accesses to the LUT, i.e., reference that is performed in order to read a distortion compensation coefficient to perform multiplication of a transmission signal and an update that is performed by correcting the distortion compensation coefficient from both the transmission signal and a feedback signal and writing the corrected distortion compensation coefficient. In a process of reference, because the distortion compensation coefficient with respect to the transmission signal is read, a process corresponding to a single port is performed. In contrast, in a process of an update, because already stored distortion compensation coefficients are read and updated and the updated distortion compensation coefficients are written, a process corresponding to two ports is performed. Accordingly, a process corresponding to three ports in total is performed in the reference and the update processes; however, in a usual dual port RAM, only a process corresponding to two ports is allowed.

Thus, in an update process of the LUT, the reading of the distortion compensation coefficients from the LUT and the writing of the updated distortion compensation coefficients are sometimes performed in a time division. Namely, in a reading section, the data that is used for an update is read from the LUT and stored in a memory and, in a subsequent writing section, the distortion compensation coefficients are updated by using the data stored in the memory and are written in the LUT. Consequently, in the process of referring to the LUT, it is possible to read the distortion compensation coefficients by using a single port and perform distortion compensation on the transmission signal in real time and, in an update of the LUT, it is possible to update the distortion compensation coefficients by using the rest of the single port in a time division.

Patent Document 1: Japanese Laid-open Patent Publication No. 2011-199428

Patent Document 2: Japanese Laid-open Patent Publication No. 2009-118454

Patent Document 3: Japanese Laid-open Patent Publication No. 10-293589

Patent Document 4 Japanese Laid-open Patent Publication No. 2015-192422

Incidentally, for example, in an operation test of a radio device, the same signal is repeatedly input to the radio device and it is checked that distortion compensation or the like is normally operated. In such a case, there is a problem in that, if the update of the LUT is performed, although the same signal is repeatedly input, the distortion compensation coefficient that is associated with a part of the signal is not correctly updated. Namely, in an update of the LUT, the update of the distortion compensation coefficients are separately performed in the reading section and the writing section; however, because the distortion compensation coefficient that is associated with the signal portion that always corresponds to the writing section is not read, the subject distortion compensation coefficient is not updated.

Specifically, for example, as illustrated in FIG. 8, considering the case in which the signal of 10,000 samples with the sample number of 0 to 9999 is repeatedly input to the radio device. If the LUT is configured by using a dual port RAM, one of the two ports serves as a reference port that is used to refer to a distortion compensation coefficient that is multiplied by an input signal and distortion compensation coefficients are always read in real time. In contrast, the other one of the ports serves as an update port that is used to update the distortion compensation coefficients stored in the LUT and that is used by being divided into the reading section in which the distortion compensation coefficients targeted for an update are read and a writing section in which the updated distortion compensation coefficients are written.

In the example illustrated in FIG. 8, the sections associated with each of 100 samples of, for example, 0 to 99 corresponds to the reading section and the distortion compensation coefficients of the address associated with each of the 100 samples are read from the LUT. The distortion compensation coefficients are updated in the writing section that is associated with each of the 100 samples of, for example, 100 to 199 and are then written in the LUT. In this way, because the update port is used by being divided into the reading section and the writing section, the distortion compensation coefficients that are associated with the samples corresponding to the writing section are not read from the LUT and are not targeted for the update.

Consequently, if, for example, less frequently used samples are always included in the writing section, the distortion compensation coefficients associated with the subject samples are not updated. In contrast, because the distortion compensation that uses the reference port is always used, distortion compensation that uses the distortion compensation coefficients that are not updated and that are not an optimum state is performed. As a result, the nonlinear distortion in the electrical power amplifier is not sufficiently compensated and spurious that is the emission of unneeded frequency band from the radio device is generated.

Furthermore, in also a case in which less frequently used samples are included in a reading section, if the distortion compensation coefficients in the same address are continuously read in a short time, the distortion compensation coefficients that are subsequently read is not updated due to a delay in the update process of the distortion compensation coefficients that are read first. Namely, the update of the distortion compensation coefficient is skipped and distortion compensation using optimum distortion compensation coefficients is not performed.

### SUMMARY

According to an aspect of an embodiment, a radio device includes: an amplifier that amplifies electrical power of a signal that is wirelessly sent; a storage that stores therein distortion compensation coefficients each of which compensates distortion that is generated in the amplifier; an updater that reads, from the storage in a first time section, the distortion compensation coefficients associated with a portion of an input signal input during the first time section and stores the read distortion compensation coefficients in a memory, and that updates, in a second time section, the distortion compensation coefficients stored in the memory and writes the updated distortion compensation coefficients in the storage; and a controller that controls the updater such that, when the same input signal is repeatedly input, the distortion compensation coefficients associated with a portion that is different from the portion of the input signal input the last time are stored in the memory in the first time section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a radio base station system according to a first embodiment;

FIG. 2 is a block diagram illustrating a PD processing unit according to the first embodiment;

FIG. 3 is a flowchart illustrating an update process according to the first embodiment;

FIG. 4 is a schematic diagram illustrating a specific example of the update process according to the first embodiment;

FIG. 5 is a block diagram illustrating the configuration of a PD processing unit according to a second embodiment;

FIG. 6 is a flowchart illustrating an update process according to the second embodiment;

FIG. 7 is a schematic diagram illustrating a specific example of the update process according to the second embodiment; and

FIG. 8 is a schematic diagram illustrating a specific example of a port process of an LUT.

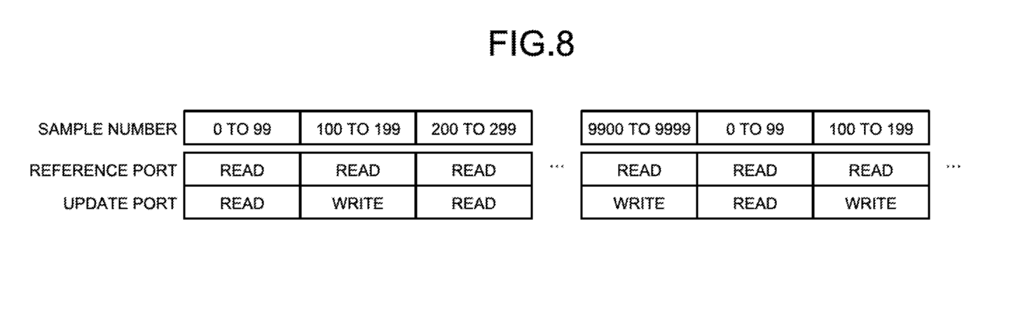

### DESCRIPTION OF EMBODIMENTS

Preferred embodiments of a radio device and a coefficient update method disclosed in the present invention will be explained in detail with reference to accompanying drawings. The present invention is not limited to the embodiments.

### [a] First Embodiment

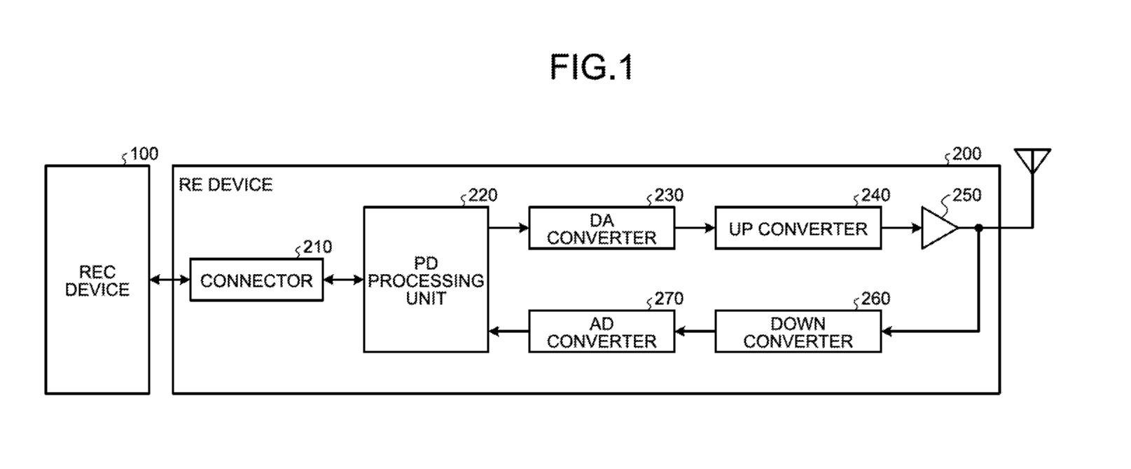

FIG. 1 is a block diagram illustrating a radio base station system according to a first embodiment. The radio base station system illustrated in FIG. 1 is configured such that a radio equipment control (REC) device 100 and a radio equipment (RE) device 200 are connected by an interface, such as a common public radio interface (CPRI), or the like.

The REC device 100 is connected to the RE device 200, generates a transmission baseband signal, and sends the generated transmission baseband signal to the RE device 200. Furthermore, the REC device 100 receives a reception baseband signal from the RE device 200 and performs a reception process.

The RE device 200 receives the transmission baseband signal sent from the REC device 100 and performs a radio transmission process. Furthermore, the RE device 200 receives a signal via an antenna, performs the radio reception process on the reception signal, and sends the obtained reception baseband signal to the REC device 100.

Specifically, the RE device 200 includes a connector 210, a predistortion processing unit (hereinafter, simply referred to as a “PD processing unit”) 220, a digital-to-analog (DA) converter 230, an up converter 240, and an electrical power amplifier 250. Furthermore, the RE device 200 includes a down converter 260 and an analog-to-digital (AD) converter 270. Furthermore, in FIG. 1, only a part related to signal transmission performed by the RE device 200 is illustrated and the part related to signal reception is not illustrated.

The connector 210 is a connector associated with, for example, an interface, such as a CPRI, or the like, and connects the RE device 200 to the REC device 100. Then, the connector 210 receives the transmission baseband signal sent from the REC device 100 and then outputs the received transmission baseband signal to the PD processing unit 220. Furthermore, the connector 210 sends the reception baseband signal to the REC device 100.

When the PD processing unit 220 receives an input of the transmission baseband signal from the connector 210, the PD processing unit 220 performs distortion compensation that multiplies a distortion compensation coefficient by an input signal and outputs the obtained compensation signal to the DA converter 230. Furthermore, the PD processing unit 220 performs an update process on the distortion compensation coefficient. The configuration of the PD processing unit 220 will be described in detail later.

The DA converter 230 performs DA conversion on the compensation signal and outputs the obtained analog signal to the up converter 240.

The up converter 240 up-converts an analog signal to a radio frequency and then outputs the obtained radio signal to the electrical power amplifier 250.

The electrical power amplifier 250 amplifies the radio signal, sends the radio signal from the antenna, and feeds back the radio signal to the down converter 260. In the electrical power amplifier 250, nonlinear distortion is generated; however, the nonlinear distortion is cancelled by the distortion compensation performed by the PD processing unit 220.

The down converter 260 down-converts the feedback signal (hereinafter, simply referred to as an “FB signal”) that is fed back from the electrical power amplifier 250 to a baseband frequency and outputs the baseband FB signal to the AD converter 270.

The AD converter 270 performs AD conversion on the FB signal and outputs the obtained digital FB signal to the PD processing unit 220.

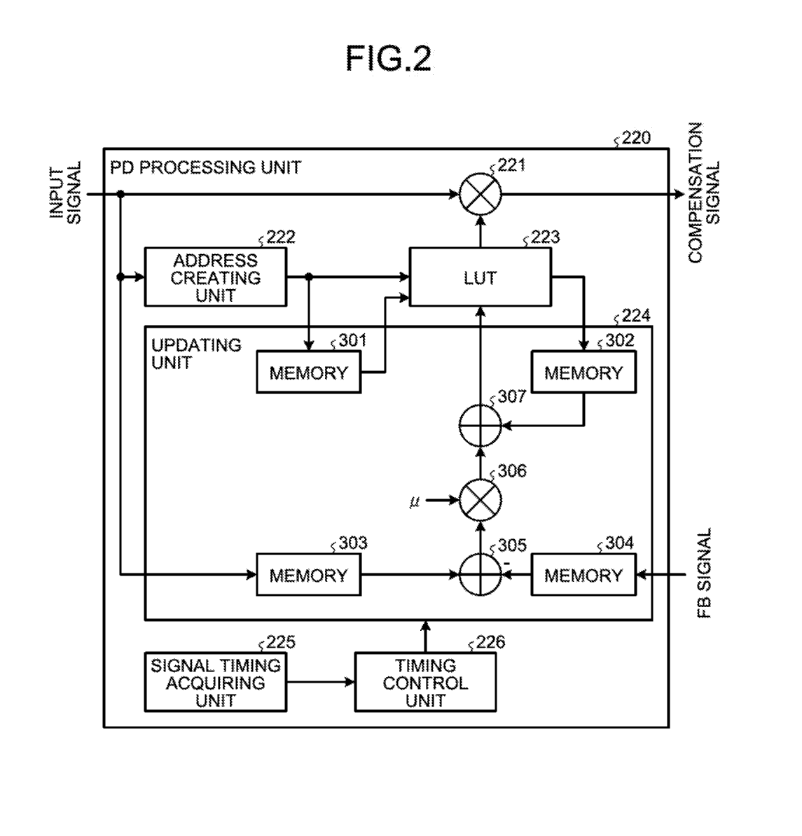

FIG. 2 is a block diagram illustrating the PD processing unit 220 according to the first embodiment. The PD processing unit 220 illustrated in FIG. 2 includes a distortion compensation unit 221, an address creating unit 222, a lookup table (LUT) 223, an updating unit 224, a signal timing acquiring unit 225, and a timing control unit 226. Furthermore, the PD processing unit 220 illustrated in FIG. 2 is configured by using a processor and a memory. As the processor, for example, a field programmable gate array (FPGA), an application specific integrated circuit (ASIC), a digital signal processor (DSP), a central processing unit (CPU), or the like may be used. Furthermore, as the memory, for example, a read only memory (ROM), a random access memory (RAM), a dual port RAM, or the like may be used.

The distortion compensation unit 221 multiplies the distortion compensation coefficient read from the LUT 223 by an input signal and performs distortion compensation on the input signal. Namely, the distortion compensation unit 221 acquires, from the LUT 223, the distortion compensation coefficient that has the inverse characteristic of the nonlinear distortion generated in the electrical power amplifier 250, multiplies the distortion compensation coefficient by the input signal, and generates the compensation signal in which the nonlinear distortion has been compensated.

The address creating unit 222 creates, on the basis of the input signal, the address of the distortion compensation coefficient that is associated with the input signal. Specifically, the address creating unit 222 generates the address that is associated with the electrical power of, for example, the input signal and notifies the LUT 223 of the generated address. Furthermore, the address creating unit 222 also notifies the updating unit 224 of the generated address.

The LUT 223 stores therein a distortion compensation coefficient of each of a plurality of the addresses. Then, when the LUT 223 receives an address from the address creating unit 222 as a notification, the LUT 223 outputs the distortion compensation coefficient stored in the notified address to both the distortion compensation unit 221 and the updating unit 224. Each of the distortion compensation coefficients stored in the LUT 223 is updated by the updating unit 224. If the LUT 223 is configured by using a dual port RAM, one of the ports is used by the distortion compensation unit 221 to refer to the distortion compensation coefficients and the other one of the ports is used by the updating unit 224 to update the distortion compensation coefficients.

The updating unit 224 reads, from the LUT 223, the distortion compensation coefficients of the address created by the address creating unit 222 in order to perform an update and updates the distortion compensation coefficients on the basis of an error between the input signal and the FB signal. Then, the updating unit 224 writes the updated distortion compensation coefficients in the LUT 223. At this time, the updating unit 224 stores, in the reading section in the memory, various kinds of information used to update the distortion compensation coefficients in accordance with the control performed by the timing control unit 226. Then, when the writing section arrives, the updating unit 224 updates the distortion compensation coefficients by using various kinds of information stored in the memory and writes the distortion compensation coefficients in the LUT 223.

Specifically, the updating unit 224 includes memories 301 to 304, a subtracter 305, a multiplier 306, and an adder 307.

In the reading section, the memory 301 temporarily stores therein the address created by the address creating unit 222 and, in the writing section, the memory 301 sequentially outputs, to the LUT 223, the stored addresses as the write address of the updated distortion compensation coefficients.

In the reading section, the memory 302 temporarily stores therein the distortion compensation coefficients that are the same as those output from the LUT 223 to the distortion compensation unit 221 and, in the writing section, the memory 302 sequentially outputs, to the adder 307, the stored distortion compensation coefficients.

In the reading section, the memory 303 temporarily stores therein the input signals that are the same as those input to the distortion compensation unit 221 and, in the writing section, the memory 303 sequentially outputs the stored input signals to the subtracter 305.

In the reading section, the memory 304 temporarily stores therein the FB signal that is fed back from the electrical power amplifier 250 and, in the writing section, the memory 304 sequentially the stored FB signals to the subtracter 305.

Furthermore, because a delay is generated in a process until the FB signal is fed back to the PD processing unit 220, each of the pieces of information stored in the memories 301 to 303 is appropriately delayed and, in each of the memories 301 to 304, the information on the associated timing is stored. Namely, the address, the distortion compensation coefficient, the input signal, and the FB signal that are associated with the same input signal are stored in the memories 301 to 304, respectively. Furthermore, each of the memories 301 to 304 stores therein, in the reading section, the information corresponding to an amount of each predetermined memory size. Namely, if the memory size is set to an amount corresponding to, for example, 100 samples of an input signal, the memory 303 stores therein, in the reading section, the 100 samples of the input signal. Then, the memories 301, 302, and 304 stores therein the address, the distortion compensation coefficient, and the FB signal, respectively, that are associated with the 100 samples.

The subtracter 305 calculates an error between the input signal stored in the memory 303 and the FB signal stored in the memory 304. If ideal distortion compensation has been performed by the distortion compensation unit 221, the error calculated by the subtracter 305 becomes zero. Thus, the distortion compensation coefficient that reduces the error calculated by the subtracter 305 is an appropriate distortion compensation coefficient.

The multiplier 306 multiplies a predetermined parameter μ by the error calculated by the subtracter 305. Consequently, the multiplier 306 calculates an amount of update for the distortion compensation coefficient in order to reduce the error between the input signal and the FB signal. Furthermore, the predetermined parameter μ is a step size parameter or the like that is determined by, for example, a least mean square (LMS) method.

The adder 307 adds the amount of update obtained by the multiplier 306 to the distortion compensation coefficient stored in the memory 302. Namely, the adder 307 updates the distortion compensation coefficients read from the LUT 223 in the reading section such that the error between the input signal and the FB signal is made small.

The subtracter 305, the multiplier 306, and the adder 307 perform, in the writing section, the process described above and update the distortion compensation coefficients. Then, the distortion compensation coefficients that have been updated by the adder 307 are written in the write address that is output from the memory 301. In this way, because the pieces of information stored in the memories 301 to 304 are used in the reading section, the distortion compensation coefficients are updated in the writing section and are written in the LUT 223.

The signal timing acquiring unit 225 acquires the timing in which a signal is input to the PD processing unit 220. Namely, in the radio communication system that uses, for example, time division duplex (TDD), because transmission and reception is performed in a different timing, the signal timing acquiring unit 225 acquires the transmission timing of the signal as the timing in which the signal is input to the PD processing unit 220. Furthermore, if the same signal is repeatedly input to the PD processing unit 220 due to an operation test of, for example, the RE device 200, the signal timing acquiring unit 225 acquires the top timing of each of the signals that are repeatedly input.

The timing control unit 226 controls the reading section and the writing section in the updating unit 224 by using, as the reference, the timing in which the signal was acquired by the signal timing acquiring unit 225. Specifically, if the same signal is repeatedly input to the PD processing unit 220, the timing control unit 226 shifts the reading section and the writing section by each predetermined width every time the signal is repeatedly input. Namely, if a signal is input to the PD processing unit 220 for the first time, the timing control unit 226 starts the reading section at the same time of the top timing of this signal and allows each of the memories 301 to 304 in the updating unit 224 to store the information. Then, if the signal is input to the PD processing unit 220 the next time, the timing control unit 226 starts the reading section delayed by an amount corresponding to, for example, 1 sample from the top timing of this signal and allows each of the memories 301 to 304 in the updating unit 224 to store the information.

In this way, every time the signal is repeatedly input to the PD processing unit 220, the timing control unit 226 shifts the update timing constituted by the reading section and the writing section by each 1 sample. Consequently, every time the signal is repeatedly input, a different signal portion corresponds to the reading section and the information that is associated with the different signal portion is stored in each of the memories 301 to 304.

Furthermore, the timing control unit 226 does not always need to shift the update timing by each 1 sample but may also shift the update timing by the width corresponding to equal to or greater than 2 samples. Furthermore, instead of shifting the update timing by each predetermined width, the timing control unit 226 may also generate a random number every time the signal is repeatedly input and may also delay the update timing from the top timing of the signal by the width corresponding to the generated random number.

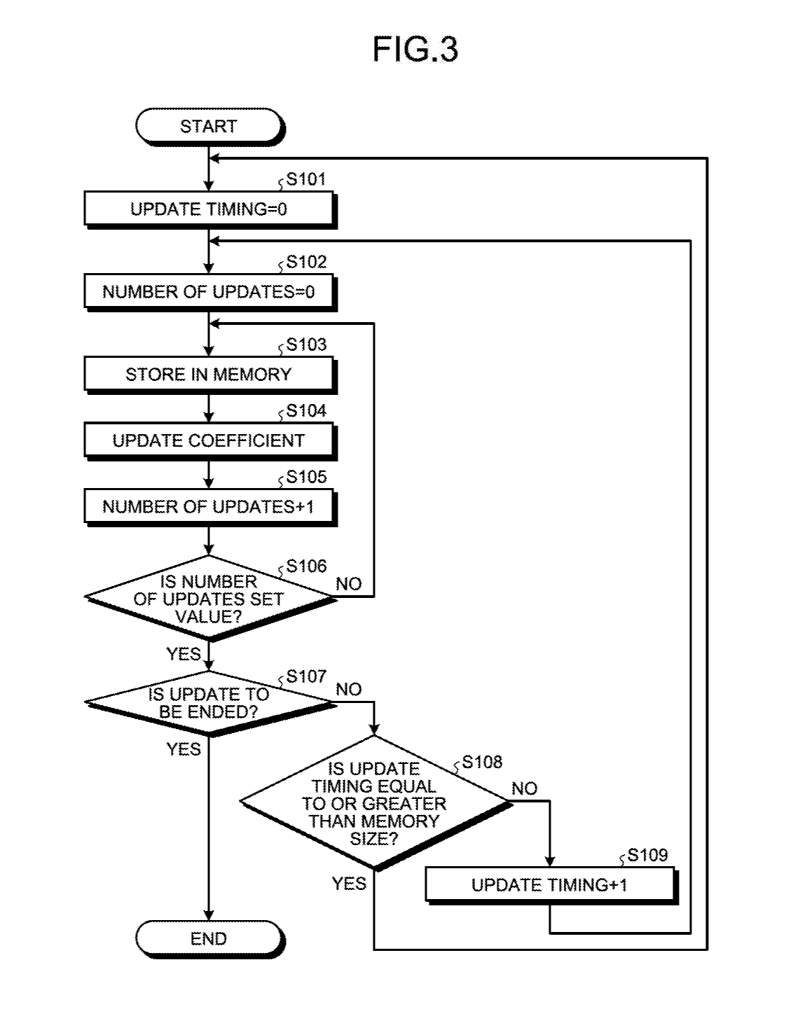

Then, the update process of the distortion compensation coefficients performed by the PD processing unit 220 configured described above will be described with reference to the flowchart illustrated in FIG. 3. In the following, a description will be given of an update process performed when the same signal is repeatedly input to the PD processing unit 220.

If a signal is input to the PD processing unit 220 for the first time, the update timing and the number of updates are initialized. Specifically, the update timing that indicates the timing of each of the reading section and the writing section is initialized to zero (Step S101) and the number of updates that indicates the number of repetitions of both the reading section and the writing section performed on the entirety of the input signal is initialized to zero (Step S102). The update timing and the number of updates are managed by the timing control unit 226.

Then, if the signal is input to the PD processing unit 220, the timing of the process performed by the updating unit 224 is controlled by the timing control unit 226. Specifically, the start of the reading section is instructed to the updating unit 224 by the timing control unit 226 by using, as a reference, the top timing of the input signal acquired by the signal timing acquiring unit 225. Namely, the reading section is started at the timing delayed by the current update timing (in this case, zero) from the top timing of the input signal.

If the reading section is started, the addresses, the distortion compensation coefficients, the input signal, and the FB signal are stored by the memories 301 to 304, respectively, in the updating unit 224 (Step S103). At this time, the information with the predetermined memory size corresponding to, for example, 100 samples of the input signal is stored in each of the memories 301 to 304. Namely, the input signal with an amount corresponding to the memory size is stored in the memory 303 and the address created from this input signal by the address creating unit 222 is stored in the memory 301. Furthermore, the address created by the address creating unit 222 is output to the LUT 223 and the distortion compensation coefficients stored in the associated addresses are stored in the memory 302. Furthermore, the FB signal associated with the input signal stored in the memory 303 is stored in the memory 304.

In the reading section, if the information with the predetermined memory size is stored in the memories 301 to 304, the writing section is started. Namely, by using the information stored in the memories 301 to 304, the distortion compensation coefficients are updated (Step S104). Specifically, the error between the input signal stored in the memory 303 and the FB signal stored in the memory 304 is calculated by the subtracter 305. Then, the predetermined parameter μ is multiplied by the error by the multiplier 306 and the obtained amount of update is added, by the adder 307, to the distortion compensation coefficients stored in the memory 302. Consequently, new distortion compensation coefficients that reduce the error between the input signal and the FB signal are calculated. The new distortion compensation coefficients are written in the write address in the LUT 223 stored in the memory 301.

If the reading section and the writing section that are associated with the predetermined memory size has been completed in this way, the number of updates is incremented by 1 by the timing control unit 226 (Step S105). Namely, because the entire size of the input signal is sufficiently greater than the memory size of the information that is stored in the reading section in each of the memories 301 to 304, the reading section and the writing section are repeated during the time period in which the entirety of the signal is input to the PD processing unit 220. The number of repetitions mentioned here is counted as the number of updates. The upper limit of the number of updates is the same as the number of appearances of the reading sections and the writing sections that are repeated in a period of time from when the entirety of the input signal is input to the PD processing unit 220 until when the entirety of the input signal is output and is previously stored by the timing control unit 226 as a set value.

Then, it is determined, by the timing control unit 226, whether the number of updates reaches the previously stored set value (Step S106) and, until the number of updates reaches the set value (No at Step S106), the reading section and the writing section are repeated and the distortion compensation coefficients are updated. Then, if the update using the entirety of the input signal has been completed and the number of updates reaches the set value (Yes at Step S106), it is determined whether the update process needs to be ended (Step S107). This determination is performed by determining that the update process is to be ended, if, for example, the repetition of the input of the signal to the PD processing unit 220 has been completed. Namely, the same signal is repeatedly input to the PD processing unit 220; however, if the repetition of the input has been completed, the update process of the distortion compensation coefficients is also ended.

The determination whether the update process is to be ended may also be performed on the basis of, for example, the number of times the signal is repeatedly input to the PD processing unit 220. Namely, for example, if the number of repetitions of input reaches a predetermined number of times, it may also be possible to determine that the update process is to be ended. If it is determined that the update process is to be ended (Yes at Step S107), the update of the distortion compensation coefficients performed by the updating unit 224 is ended. In contrast, if it is determined that the update process is to be continued (No at Step S107), it is determined, by the timing control unit 226, whether the update timing is equal to or greater than the predetermined memory size (Step S108). Namely, in the reading section, information with the predetermined memory size corresponding to, for example, 100 samples of the input signal is stored in the memories 301 to 304 and the memory size at this point is compared with the update timing.

In this case, because the update timing is zero, the update timing is less than the memory size (No at Step S108) and the update timing is incremented by 1 by the timing control unit 226 (Step S109). Then, if the signal is input to the PD processing unit 220 for the second time, the number of updates is initialized (Step S102) and the reading section is started at the timing that is delayed by an amount corresponding to the current update timing (in this case, 1) from the top timing of the input signal. Namely, if the signal is input to the PD processing unit 220 for the first time, the reading section is started from the top sample of the input signal; however, if the signal is input to the PD processing unit 220 for the second time, the reading section is started from the sample that is the second from the top of the input signal. In this way, every time the signal is repeatedly input, the update timing is incremented by 1, whereby the reading section is shifted by each 1 sample.

Then, the reading section and the writing section are repeated regarding the signal that is input for the second time (Steps S103 to S106) and the update of the distortion compensation coefficients is performed by using the sample that is different from that of the signal that is input for the first time. In this way, every time the signal is repeatedly input to the PD processing unit 220, the update timing constituted by the reading section and the writing section is shifted by each 1 sample, whereby the entirety of the input signal can sequentially be used as the reading section and thus the distortion compensation coefficients can uniformly be updated.

If the distortion compensation coefficients are updated by shifting the update timing by each 1 sample, the update timing becomes equal to or greater than the memory size that is used in the reading section before long. In this case (Yes at Step S108), due to shifting the update timing, all of the samples included in the writing section of the signal that is input to the PD processing unit 220 for the first time are included in the reading section later. Thus, when the subsequent signal is input to the PD processing unit 220, the update timing is initialized (Step 5101) and the same update process as that performed when the first signal is input is performed.

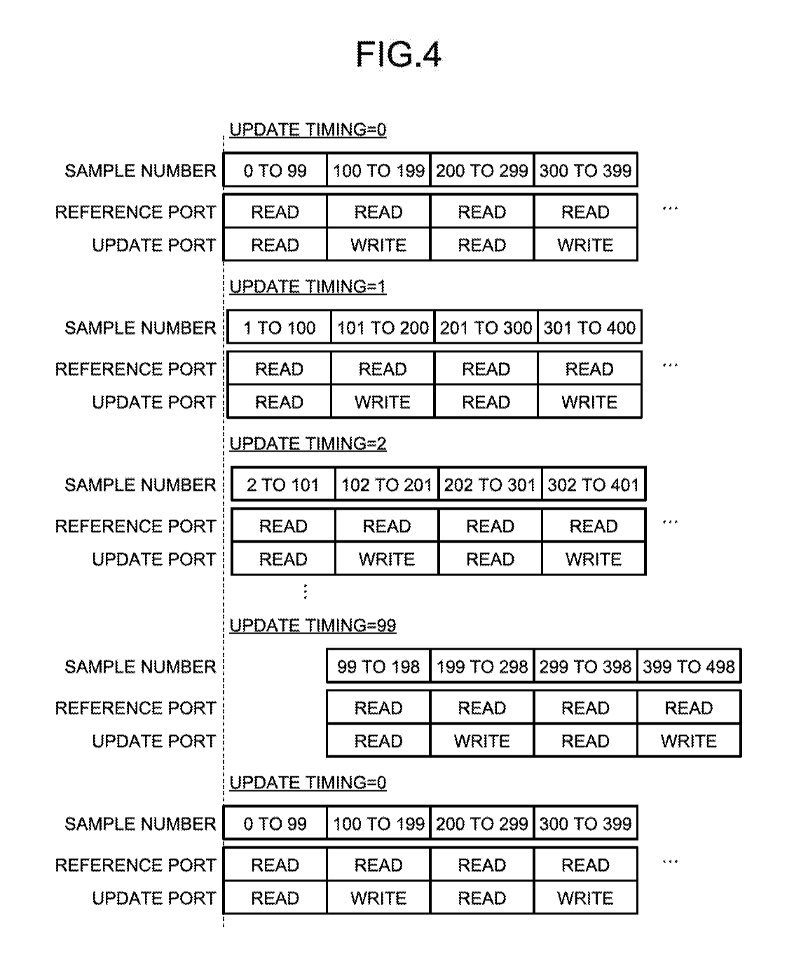

In the following, a specific example of the update process of the distortion compensation coefficients according to the first embodiment will be described with reference to FIG. 4.

As illustrated in FIG. 4, if the LUT 223 is constituted by using a dual port RAM, one of the ports serves as a reference port that is used to refer to a distortion compensation coefficient that is multiplied by the input signal and the distortion compensation coefficient is always read in real time. In contrast, the other one of the ports serves as an update port that is used to update the distortion compensation coefficients stored in the LUT 223 and that is used by being divided into the reading sections that read the distortion compensation coefficients targeted for the update and the writing sections that write the updated distortion compensation coefficients.

It is assumed that each of the reading section and the writing section corresponds to the amount of 100 samples of the input signal and, in the reading section, the information associated with the amount of 100 samples of the input signal is stored in each of the memories 301 to 304. Accordingly, if the first signal is input to the PD processing unit 220, in each of the reading sections, the information associated with each of the 100 samples of, for examples, 0 to 99, 200 to 299, or the like, of the input signal is input to the memories 301 to 304. Furthermore, in the writing section subsequent to each of the reading sections, the distortion compensation coefficients are updated by using the information stored in the memories 301 to 304 and are written in the LUT 223. Consequently, if a signal is input to the PD processing unit 220 for the first time, only the distortion compensation coefficients associated with each of the 100 samples of, for example, 0 to 99, 200 to 299, or the like, of the input signal are updated.

Then, when the subsequent signal is input to the PD processing unit 220, because the update timing is incremented, in the reading sections, the information associated with each of the 100 samples of, for example, 1 to 100, 201 to 300, or the like, of the input signal is stored in the memories 301 to 304. Furthermore, in the writing section subsequent to each of the reading sections, the distortion compensation coefficients are updated by using the information stored in the memories 301 to 304 and the distortion compensation coefficients are written in the LUT 223. Consequently, if the signal is input to the PD processing unit 220 for the second time, only the distortion compensation coefficients associated with each of the 100 samples of, for example, 0 to 99, 200 to 299, or the like, of the input signal are updated.

From this point, every time the signal is input to the PD processing unit 220, the update timing is incremented and then the reading section and the writing section are shifted by each 1 sample. Consequently, in the update port, the samples associated with the reading sections are changed and the distortion compensation coefficients that are associated with the entirety of the input signal can uniformly be updated. As a result, it is possible to improve the accuracy of the distortion compensation coefficients stored in the LUT 223 and it is possible to reduce the spurious by appropriate distortion compensation.

Then, if the signal is input to the PD processing unit 220 for the 100^{th} time, the update timing has been incremented up to 99, which indicates that the samples that were included in the writing section when the update timing is zero are included in the reading section. Consequently, when the signal is input to the PD processing unit 220 for the 101^{th} time, the update timing is initialized to zero and the same update process as that performed when the signal is input to the PD processing unit 220 for the first time is performed.

As described above, according to the embodiment, if the same signal is repeatedly input to the PD processing unit, the update timing constituted by the reading section and the writing section is shifted every time the signal is repeatedly input. Consequently, every time the signal is repeatedly input, the distortion compensation coefficients associated with a different portion of the input signal are read from the LUT in the reading section, are stored in the memory, and are updated in the writing section. Accordingly, the distortion compensation coefficients associated with the entirety of the input signal are uniformly read from the LUT and are updated, which makes it possible to increase the accuracy of the distortion compensation coefficients. As a result, the distortion compensation of the input signal is appropriately performed and thus the spurious can be reduced.

### [b] Second Embodiment

The characteristic of a second embodiment is that, every time the same signal is repeatedly input, the memory size stored in the reading section is changed and the distortion compensation coefficients stored in the LUT are uniformly updated.

The configuration of a radio base station system according to the second embodiment is the same as that of the first embodiment (FIG. 1); therefore, descriptions thereof will be omitted. In the second embodiment, the configuration of the PD processing unit 220 is different from that described in the first embodiment.

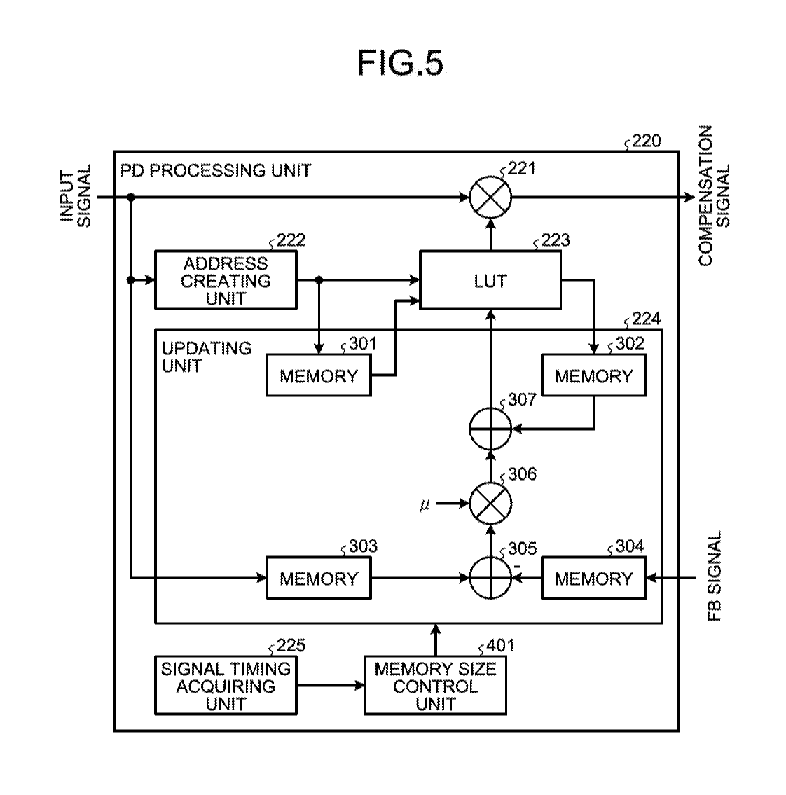

FIG. 5 is a block diagram illustrating the configuration of the PD processing unit 220 according to a second embodiment. In FIG. 5, the components having the same configuration as those illustrated in FIG. 2 are assigned the same reference numerals and descriptions thereof will be omitted. The PD processing unit 220 illustrated in FIG. 5 includes a memory size control unit 401 instead of the timing control unit 226 in the PD processing unit 220 illustrated in FIG. 2.

The memory size control unit 401 controls the memory size of the reading section that is started at the timing of the signal that is acquired by the signal timing acquiring unit 225. Specifically, if the same signal is repeatedly input to the PD processing unit 220, the memory size control unit 401 increases, every time the signal is repeatedly input, the memory size of the information stored in each of the memories 301 to 304 by each predetermined width. Namely, if the signal is input to the PD processing unit 220 for the first time, the memory size control unit 401 allows each of the memories 301 to 304 in the updating unit 224 to store the information associated with, for example, 100 samples from the top of the input signal in the first reading section. Then, if the same signal is input to the PD processing unit 220 for the next time, the memory size control unit 401 allows each of the memories 301 to 304 in the updating unit 224 to store the information associated with, for example, 101 samples from the top of the input signal in the first reading section.

In this way, every time the signal is repeatedly input to the PD processing unit 220, the memory size control unit 401 increases the memory size of the information that is stored in the memories 301 to 304 by each 1 sample in the reading section. Consequently, every time the signal is repeatedly input, a different signal portion corresponds to the reading section and the information that is associated with the different signal portion is stored in each of the memories 301 to 304.

Furthermore, the memory size control unit 401 does not always need to increase the memory size by each 1 sample and may also increase the memory size by the width equal to or greater than 2 samples. Furthermore, instead of increasing the memory size, the memory size control unit 401 may also decrease the memory size or may also change the memory size in accordance with the random number that is generated every time the signal is repeatedly input.

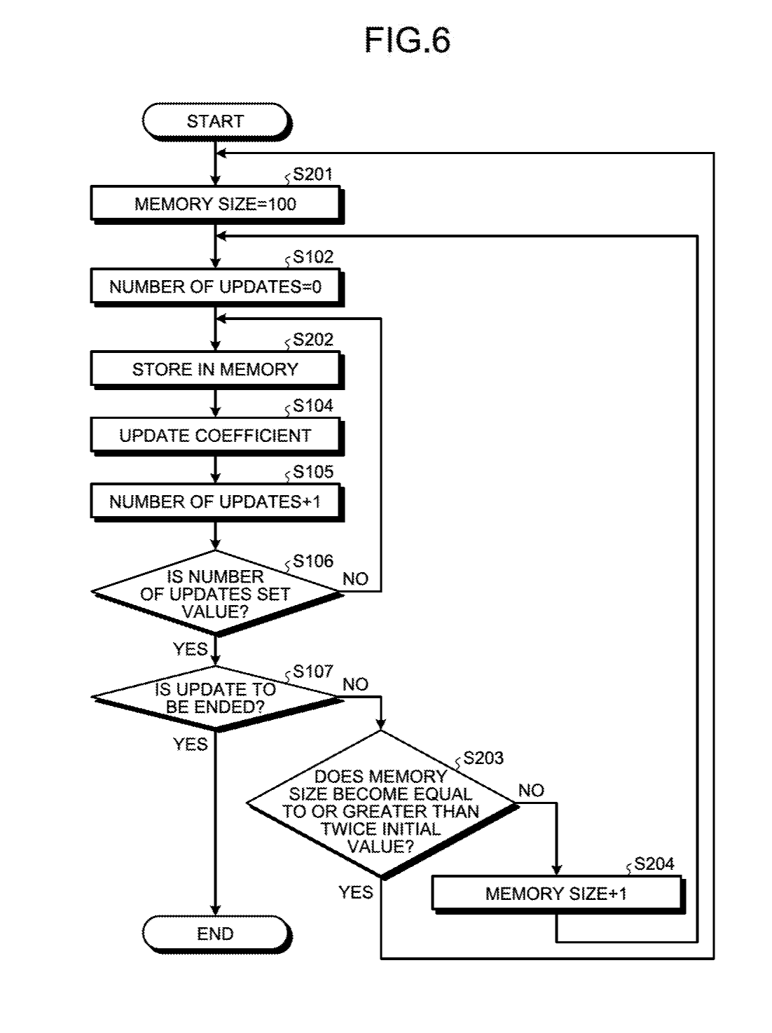

In the following, an update process of the distortion compensation coefficients performed by the PD processing unit 220 having the configuration described above will be described with reference to the flowchart illustrated in FIG. 6. In FIG. 6, the components having the same configuration as those illustrated in FIG. 3 are assigned the same reference numerals and descriptions thereof in detail will be omitted. In the following, the update process performed when the same signal is repeatedly input to the PD processing unit 220 will be described.

If a signal is input to the PD processing unit 220 for the first time, the memory size and the number of updates are initialized. Specifically, the memory size of the information stored in the memories 301 to 304 in the reading section is initialized to 100 samples that are the predetermined initial values (Step S201) and the number of updates is initialized to zero (Step S102). The memory size and the number of updates are managed by the memory size control unit 401.

Then, if the signal is input to the PD processing unit 220, the memory size in the reading section is set by the memory size control unit 401. Specifically, the memory size control unit 401 instructs the memories 301 to 304 to store, in the reading section, the information associated with the input signal with the current memory size (in this case, 100 samples). In response to this instruction, the addresses, the distortion compensation coefficients, the input signals, and the FB signals associated with each of the memory sizes are stored in the memories 301 to 304, respectively, in the updating unit 224 (Step S202). Namely, the input signals with the amount corresponding to the memory size are stored in the memory 303 and the addresses created from the input signals by the address creating unit 222 are stored in the memory 301. Furthermore, the addresses created by the address creating unit 222 are output to the LUT 223 and the distortion compensation coefficients stored in the subject addresses are stored in the memory 302. Furthermore, the FB signals associated with the input signals stored in the memory 303 are stored in the memory 304.

In the reading section, if the information with the memory size that is set by the memory size control unit 401 is stored in each of the memories 301 to 304, the writing section is started. Namely, by using the information stored in the memories 301 to 304, the distortion compensation coefficients are updated (Step S104). Namely, new distortion compensation coefficients that decrease the error between the input signal and the FB signal are calculated by the subtracter 305, the multiplier 306, and the adder 307. The new distortion compensation coefficients are written in the write address in the LUT 223 stored in the memory 301.

If the reading sections and the writing sections associated with the predetermined memory size have been completed in this way, the number of updates is incremented by 1 by the memory size control unit 401 (Step S105). Then, it is determined, by the memory size control unit 401, whether the number of updates has reached the previously stored set value (Step S106) and, until the number of updates reaches the set value (No at Step S106), the reading section and the writing section are repeated and the distortion compensation coefficients are updated. Then, if the update that is performed by the entirety of the input signal has been completed and the number of updates reaches the set value (Yes at Step S106), it is determined whether the update process is to be ended (Step S107).

In this determination, if it is determined that the update process is to be ended (Yes at Step S107), the update of the distortion compensation coefficients performed by the updating unit 224 is ended. In contrast, if it is determined that the update process is to be continued (No at Step S107), it is determined, by the memory size control unit 401, whether the memory size becomes equal to or greater than twice the initial value (Step S203). Namely, the memory size that is currently set by the memory size control unit 401 is compared with the initial value obtained when the first signal is input to the PD processing unit 220.

In this case, because the memory size remains 100 samples of the initial value, the memory size is less than twice the initial value (No at Step S203), the memory size is incremented by 1 by the memory size control unit 401 (Step S204). Then, if the signal is input to the PD processing unit 220 for the second time, the number of updates is initialized (Step S102), in the reading section, the information associated with the input signal of the current memory size (in this case, 101 samples) is stored in the memories 301 to 304. Namely, when the signal is input to the PD processing unit 220 for the first time, the information associated with the 100 samples of the input signal in the reading section is stored in the memories 301 to 304, whereas, when the signal is input to the PD processing unit 220 for the second time, information associated with 101 samples of the input signal is stored in the memories 301 to 304. In this way, because the memory size is incremented by 1 every time the signal is repeatedly input, the information stored in the memories 301 to 304 in the reading section is changed.

Then, also regarding the signal that is input for the second time, the reading section and the writing section are repeated (Steps S202 to S106), the update of the distortion compensation coefficients by using the samples that are different from the samples of the signal that is input for the first time. In this way, every time the signal is input to the PD processing unit 220, by increasing the memory size in the reading section by each 1 sample, it is possible to sequentially set the entirety of the input signal to the reading section and it is possible to uniformly update the distortion compensation coefficients.

If the distortion compensation coefficients are updated by sequentially increasing the memory size by each 1 sample, the memory size becomes equal to or greater than twice the initial value before too long. In this case (Yes at Step S203), by increasing the memory size, all of the samples included in the writing section of the signal that is input to the PD processing unit 220 for the first time are included in the reading section after that time. Thus, when the subsequent signal is input to the PD processing unit 220, the memory size is initialized (Step S201) and the same update process as that performed when the first signal is input is performed.

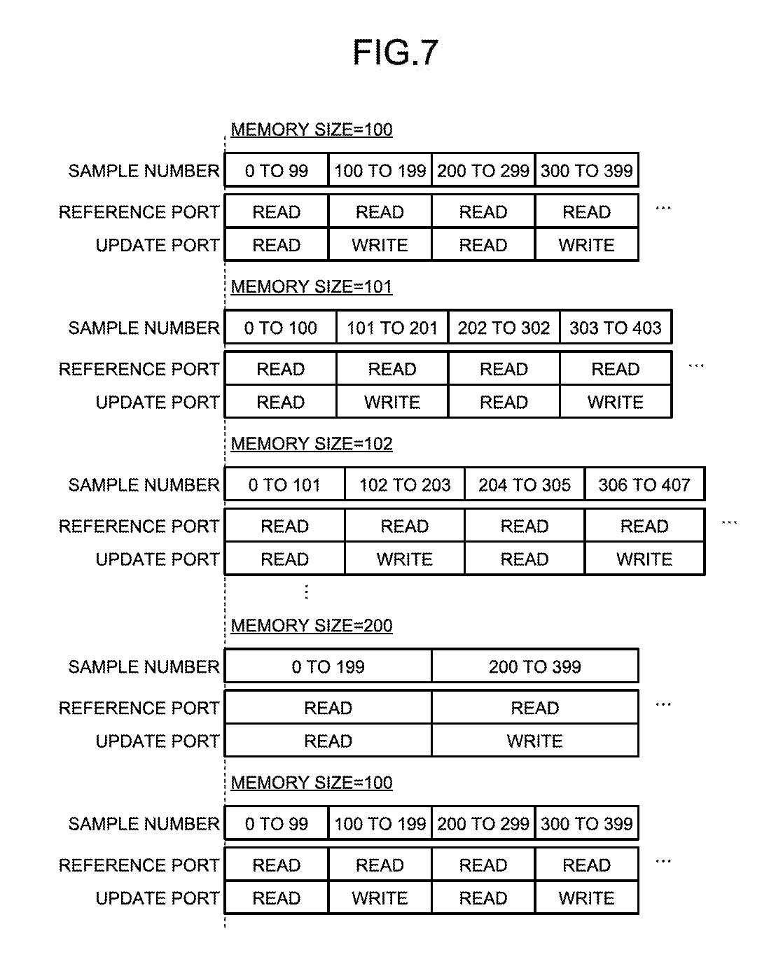

In the following, a specific example of the update process of the distortion compensation coefficients according to the second embodiment will be described with reference to FIG. 7.

As illustrated in FIG. 7, if the LUT 223 is constituted by a dual port RAM, one of the ports serves as the reference port that is used to refer to a distortion compensation coefficient that is multiplied by the input signal and the distortion compensation coefficient is always read in real time. In contrast, the other one of the ports serves as the update port that is used to update the distortion compensation coefficients stored in the LUT 223 and that is used by being divided into the reading section that reads the distortion compensation coefficients targeted for the update and the writing section that writes the updated distortion compensation coefficients.

It is assumed that, when the first signal is input to the PD processing unit 220, the memory size is set to 100 samples by the memory size control unit 401. Consequently, if the first signal is input to the PD processing unit 220, in each of the reading sections, the information associated with each of the 100 samples of, for example, 0 to 99, 200 to 299, or the like, of the input signal is stored in the memories 301 to 304. Furthermore, in the writing section subsequent to each of the reading sections, the distortion compensation coefficients are updated by using the information stored in the memories 301 to 304 and the distortion compensation coefficients are written in the LUT 223. Consequently, when the signal is input to the PD processing unit 220 for the first time, only the distortion compensation coefficients that are associated with each of the 100 samples of, for example, 0 to 99, 200 to 299, or the like, of the input signal are updated.

Then, when the subsequent signal is input to the PD processing unit 220, because the memory size has been incremented, in each of the reading sections, the information associated with each of the 101 samples of, for example, 0 to 100, 202 to 302, or the like, of the input signal are stored in the memories 301 to 304. Furthermore, in the writing section subsequent to each of the reading sections, the distortion compensation coefficients are updated by using the information stored in the memories 301 to 304 and the distortion compensation coefficients are written in the LUT 223. Consequently, when the signal is input to the PD processing unit 220 second time, only the distortion compensation coefficients associated with each of the 101 samples of, for example, 0 to 100, 202 to 302, or the like, of the input signal are updated.

From this point, the memory size is incremented every time a signal is input to the PD processing unit 220 and the memory size of the information that is read in the reading section is increased by each 1 sample. Consequently, in the update port, the samples associated with the reading section are changed and the distortion compensation coefficients associated with the entirety of the input signal can uniformly be updated. As a result, it is possible to improve the accuracy of the distortion compensation coefficients stored in the LUT 223 and it is possible to reduce the spurious by the appropriate distortion compensations.

Then, when the signal is input to the PD processing unit 220 for the 101^{th} time, the memory size has been incremented up to the 200 samples, which indicates that the memory size reaches twice as many as 100 samples of the initial value. Consequently, when the signal is input to the PD processing unit 220 for the 102^{th} time, the memory size is initialized to the 100 samples and the same update process as that performed when the signal is input to the PD processing unit 220 for the first time is performed.

As described above, according to the embodiment, if the same signal is repeatedly input to the PD processing unit, every time the signal is repeatedly input, the memory size of the information stored in the memory in the reading section is increased. Consequently, every time the signal is repeatedly input, the distortion compensation coefficients associated with a different portion of the input signal are read from the LUT in the reading section, are stored in the memory, and are updated in the writing section. Accordingly, the distortion compensation coefficients associated with the entirety of the input signal are uniformly read from the LUT and are updated, which makes it possible to increase the accuracy of the distortion compensation coefficients. As a result, the distortion compensation of the input signal is appropriately performed and thus the spurious can be reduced.

Furthermore, in each of the embodiments, the radio base station system that includes the REC device 100 and the RE device 200 has been described; however, the PD processing unit 220 according to each of the embodiments may also be provided in, for example, a radio base station device or the like.

According to an aspect of an embodiment of the radio device and the coefficient update method disclosed in the present application, an advantage is provided in that the distortion compensation coefficients stored in a lookup table are uniformly updated and the spurious can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio device comprising:
an amplifier that amplifies electrical power of a signal that is wirelessly sent;
a storage that stores therein distortion compensation coefficients each of which compensates distortion that is generated in the amplifier;
an updater that reads, from the storage in a first time section, the distortion compensation coefficients associated with a portion of an input signal input during the first time section and stores the read distortion compensation coefficients in a memory, and that updates, in a second time section, the distortion compensation coefficients stored in the memory and writes the updated distortion compensation coefficients in the storage; and
a controller that controls the updater such that, when the same input signal is repeatedly input, the distortion compensation coefficients associated with a portion that is different from the portion of the input signal input the last time are stored in the memory in the first time section.

2. The radio device according to claim 1, wherein the controller sets, when the same input signal is repeatedly input, a start timing of the first time section obtained on the basis of a top of the input signal to the start timing that is different from the start timing used the last time.

3. The radio device according to claim 1, wherein the controller sets, when the same input signal is repeatedly input, a memory size corresponding to a number of distortion compensation coefficients stored in the memory in the first time section to the memory size that is different from the memory size used the last time.

4. A coefficient update method performed by a radio device that includes an amplifier that amplifies electrical power of a signal that is wirelessly sent and a storage that stores therein distortion compensation coefficients each of which compensates distortion generated in the amplifier, the coefficient update method comprising:
reading, from the storage in a first time section, the distortion compensation coefficients associated with a portion of an input signal input during the first time section and storing the read distortion compensation coefficients in a memory;
updating, in a second time section, the distortion compensation coefficients stored in the memory and writing the updated distortion compensation coefficients in the storage; and
controlling the reading and the storing such that, when the same input signal is repeatedly input, the distortion compensation coefficients associated with a portion that is different from the portion of the input signal input the last time are stored in the memory in the first time section.
